(19) United States
(12) Patent Application Publication
(10) Pub. No.: US 2020/0141182 A1
(43) Pub. Date: May 7, 2020

(54) ROMAN SHADE WITH WEIGHT UNITS

(71) Applicant: WEI MING SHIH, Changhua County (TW)

(72) Inventor: WEI MING SHIH, Changhua County (TW)

(21) Appl. No.: 16/244,542

(22) Filed: Jan. 10, 2019

(30) Foreign Application Priority Data
Nov. 6, 2018 (TW) 107215059

(51) Int. Cl. E06B 9/38; E06B 9/262; E06B 9/32

(52) U.S. Cl. CPC E06B 9/38; E06B 2009/2622; E06B 9/32; E06B 9/262

(57) ABSTRACT

A Roman shade includes a shade unit which includes more than two shade parts, and a tubular portion is formed on the top of the shade. The more than two shade parts are connected to each other by a first weight unit located between any two of adjacent shade parts of the more than two shade parts. A slot is defined through each of the more than two shade parts except for the lowest shade part of the shade unit. A second weight unit is connected to the lower end of the shade unit so as to maintain the shade unit to be flat and fully expanded. The second weight unit has a tongue which extends through one of the slots to maintain the shade unit in a folded status when folding the shade unit.

### BACKGROUND OF THE INVENTION

### 1. Fields of the Invention

The present invention relates to a Roman shade, and more particularly, to a Roman shade with multiple weight unit to keep the shade flat and organized.

### 2. Descriptions of Related Art

The conventional Roman shades are controlled by control ropes which hang vertically at two sides of the shade. The users pull the operation ropes to lift the shade or to lower the shade. However, the hanging control ropes cannot be hidden when the shade is scrolled upward, this may affect the aesthetic purpose of the interior design. Furthermore, younger kids may play the hanging control ropes and could wrap the control ropes around their limbs.

Therefore, some manufacturers develop rope-less shades which includes multiple magnets attached to the shade so that when the shade is folded upward, the shade can be collected by attracting the magnets with each other. There are some shortcomings for these shades. The first shortcoming is that the two ends of the shade do not have proper support so that the shade made of soft material may be deformed at the two ends thereof. The second shortcoming is that the magnets have to be carefully installed so as to attract with each other. This may cause a longer installation time required. The shortcoming is that strong wind may separate the magnets and the shade expands.

The present invention intends to provide a Roman shade which has multiple weight units so as to maintain the shade to be flat.

### SUMMARY OF THE INVENTION

The present invention relates to a Roman shade and comprises a shade unit which includes more than two shade parts, and a tubular portion is formed on the top of the shade. The more than two shade parts are connected to each other by a first weight unit located between any two of adjacent shade parts of the more than two shade parts. A slot is defined through each of the more than two shade parts except for the lowest shade part of the shade unit. A second weight unit is connected to the lower end of the shade unit so as to maintain the shade unit to be flat and fully expanded. The second weight unit has a tongue which extends through one of the slots to maintain the shade unit in a folded status when folding the shade unit.

Preferably, the tongue includes a folded portion, and a weight is securely received in the folded portion.

Preferably, the first weight units are located at inside of the shade unit.

Preferably, the tubular portion includes at least one ring connected thereto.

The primary object of the present invention is to provide a Roman shade that includes multiple weight units which ensure the shade unit to be fully expanded and flat.

Another object of the present invention is to provide a Roman shade that does not need any magnet.

Yet another object of the present invention is to provide a Roman shade which ensures that the shade unit does not unfolded under strong wind.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the inside of the Roman shade of the present invention;

FIG. 2 is a perspective view to show the outside of the Roman shade of the present invention;

FIG. 3 shows the folded status of the outside of the Roman shade of the present invention;

FIG. 4 is a side view of the illustration in FIG. 3;

FIG. 5 shows another folded status of the outside of the Roman shade of the present invention;

FIG. 6 is a side view of the illustration in FIG. 5;

FIG. 7 shows that the Roman shade of the present invention is fully folded;

FIG. 8 shows that the Roman shade of the present invention includes two rings connected to the tubular portion, and

FIG. 9 shows that the Roman shade of the present invention uses the two rings to be hooked to two hooks.

### DETAILED DESCRIPTION OF THE PREFERRED EMBODIMENT

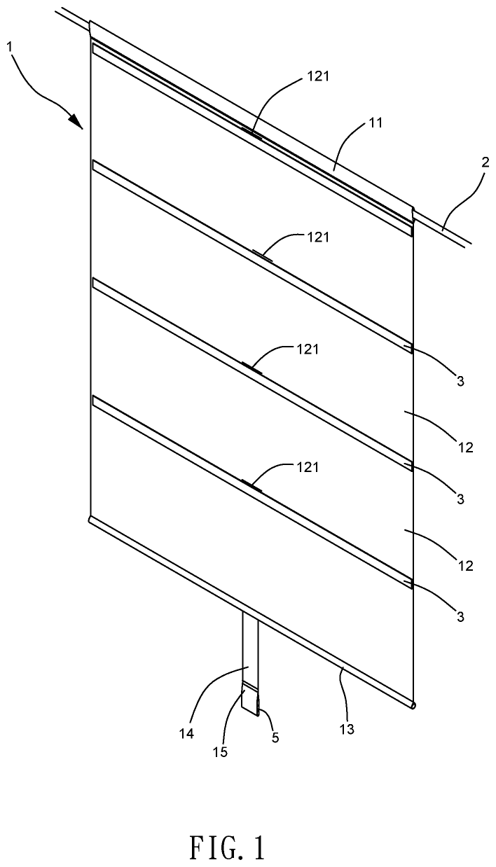

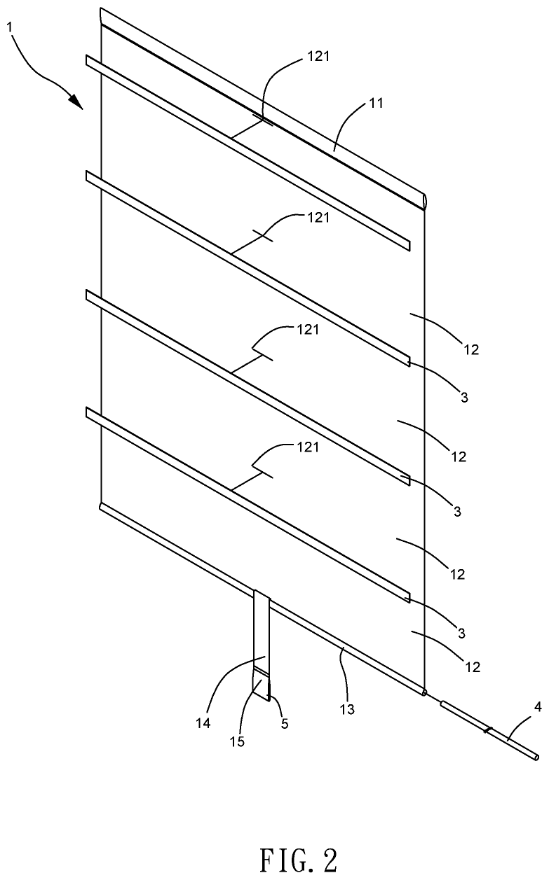

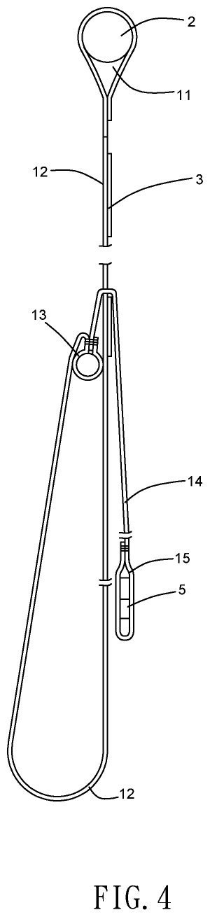

Referring to FIGS. 1 to 4, the Roman shade of the present invention comprises a shade unit 1 that includes more than two shade parts 12 which are made by fabric, and a tubular portion 11 is formed on the top of the shade 1. A rod 2 extends through the tubular portion 11 so as to be installed to a widow (not shown). In this embodiment, there are four shade parts 12 connected to each other by a first weight unit 3 located between any two of adjacent shade parts 12 of the four shade parts 12. The first weight units 3 each can be connected to the shade part 12 corresponding thereto by way of sewing, gluing or any suitable ways. The first weight units 3 are located at the inside of the shade unit 1. A slot 121 is defined centrally through each of three of the four shade parts 12 except for the lowest shade part 12 of the shade unit 1. A second weight unit 13 is connected to the lower end of the shade unit 1 and has a tongue 14 connected thereto. The tongue 14 includes a folded portion 15, and a weight 5 is securely received in the folded portion 15.

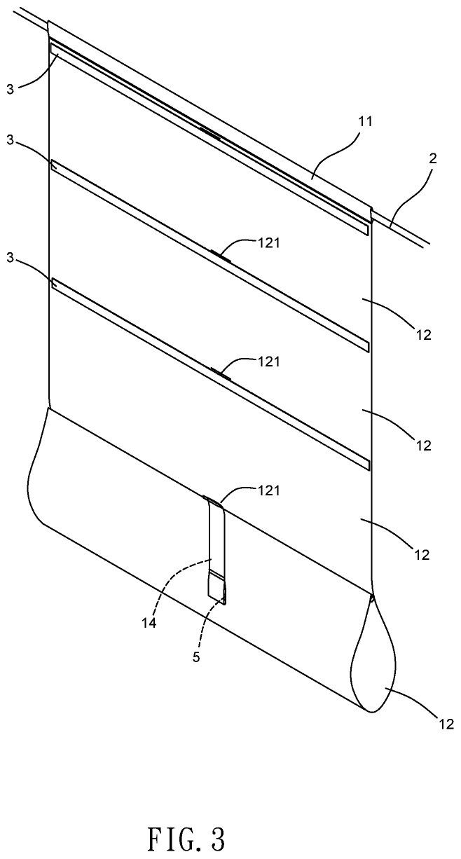

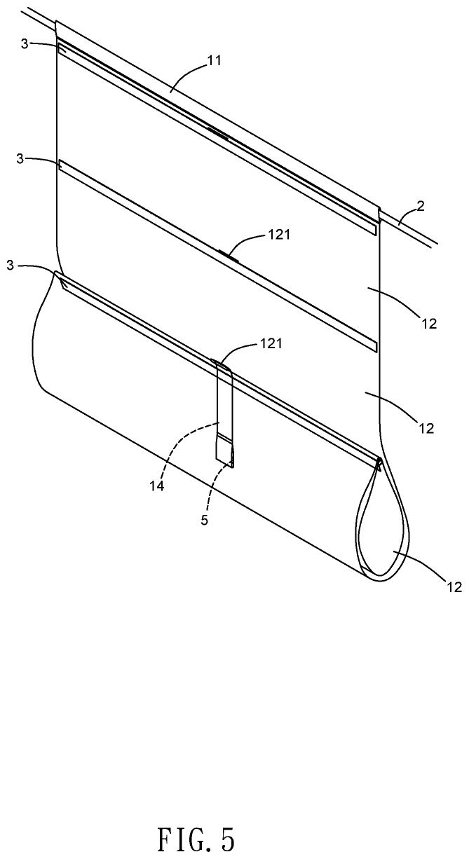

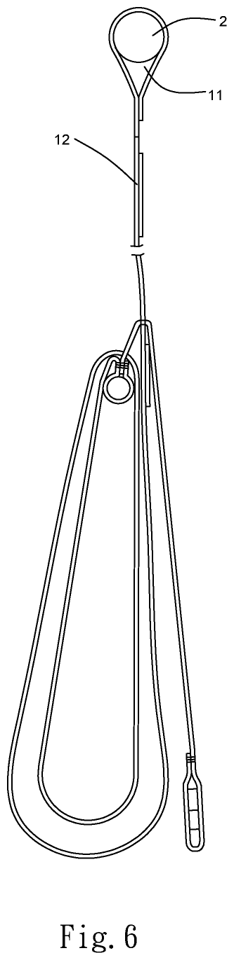

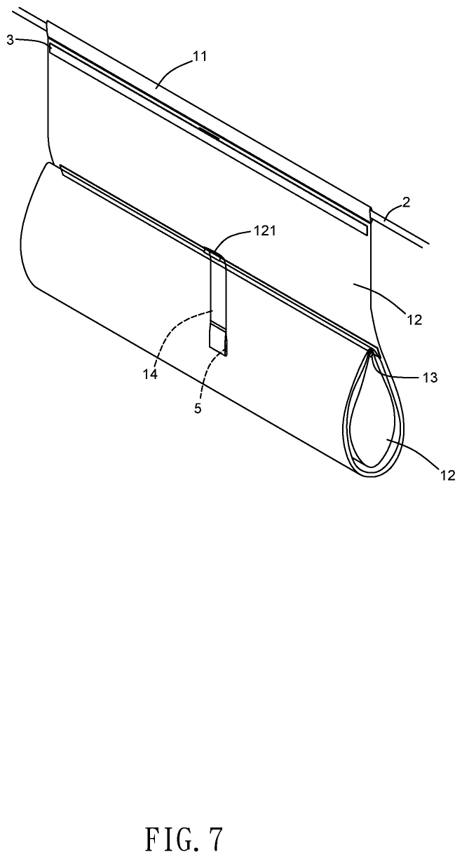

As shown in FIGS. 3 to 7, when the users want to introduce the outside light into the room, the shade unit 1 is folded upward as desired, and the tongue 14 extends through one of the slots 121 to maintain the shade unit 1 in a folded status. The weight 5 in the folded portion 15 ensures that the tongue 14 does not drop backward and separated from the slot 121. The first and second weight units 3, 13 ensure that the expanded portion of the shade unit 1 to be flat and fully expanded. The users can fold the desired number of the shade parts 12 by extending the tongue 14 through that the desired slots 121.

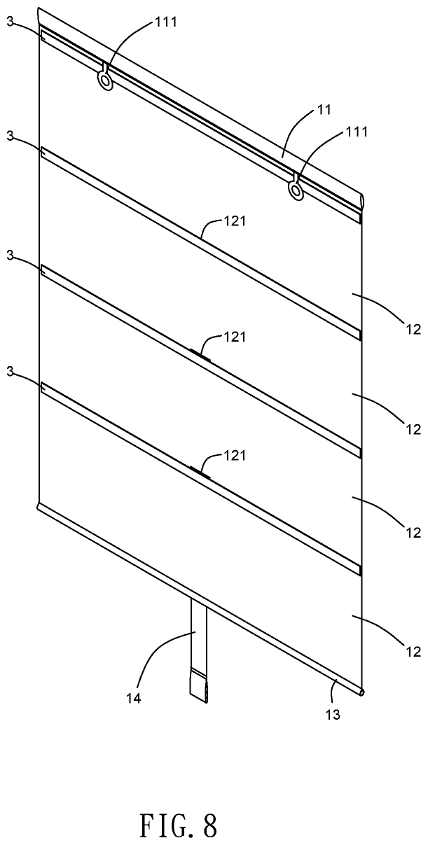

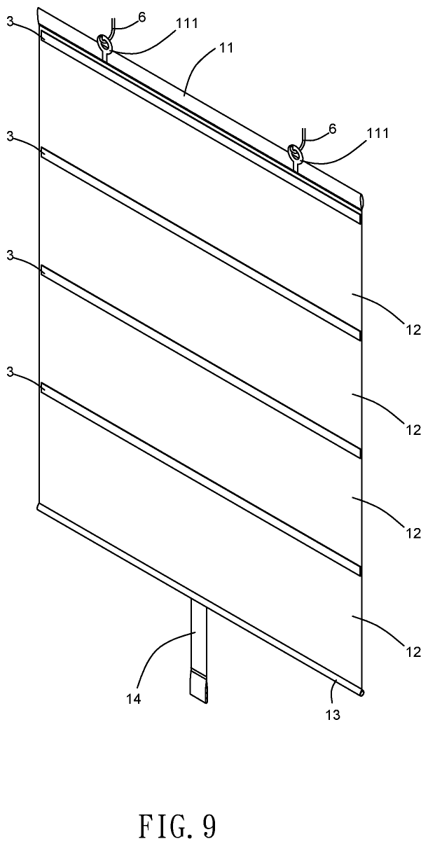

FIGS. 8 and 9 shows another embodiment of the Roman shade, wherein the tubular portion 11 includes two rings 111 connected thereto. The two rings 111 can hook to two hooks 6 on a wall so that the Roman shade does not need the rod 2.

The present invention can also be used for different types of window shades, and improves the shortcomings of the conventional shades using magnets and control ropes.

While we have shown and described the embodiment in accordance with the present invention, it should be clear to those skilled in the art that further embodiments may be made without departing from the scope of the present invention.

What is claimed is:

1. A Roman shade comprising:
a shade unit including more than two shade parts, a tubular portion formed on a top of the shade, the more than two shade parts connected to each other by a first weight unit located between any two of adjacent shade parts of the more than two shade parts, a slot defined through each of the more than two shade parts except for a lowest shade part of the shade unit, a second weight unit connected to a lower end of the shade unit, the second weight unit having a tongue connected thereto, when folding the shade unit, the tongue extends through one of the slots to maintain the shade unit in a folded status.

2. The Roman shade as claimed in claim 1, wherein the tongue includes a folded portion, and a weight is securely received in the folded portion.

3. The Roman shade as claimed in claim 1, wherein the first weight units are located at an inside of the shade unit.

4. The Roman shade as claimed in claim 1, wherein the tubular portion includes at least one ring connected thereto.

5. A Roman shade comprising:
a shade unit including four shade parts, a tubular portion formed on a top of the shade, the tubular portion adapted to receive a rod therein, the four shade parts connected to each other by a first weight unit located between any two of the four adjacent shade parts, a slot defined through each of the four shade parts except for a lowest shade part of the shade unit, a second weight unit connected to a lower end of the shade unit, the second weight unit having a tongue connected thereto, when folding the shade unit, the tongue extends through one of the slots to maintain the shade unit in a folded status.

6. The Roman shade as claimed in claim 5, wherein the first weight units are located at an inside of the shade unit.

7. The Roman shade as claimed in claim 5, wherein the tubular portion includes at least one ring connected thereto.
